(19) United States
(12) Patent Application Publication
(10) Pub. No.: US 2023/0352860 A1
(43) Pub. Date: Nov. 2, 2023

(54) METHOD FOR PRODUCING AN ELECTRICAL CONNECTION ARRANGEMENT, AND ELECTRICAL CONNECTION ARRANGEMENT

(71) Applicant: Phoenix Contact GmbH & Co. KG, Blomberg (DE)

(72) Inventors: Stefan Galla, Altenbeken (DE); Philipp Peitz, Paderborn (DE); Viktor Braun, Detmold (DE); Henning Rey, Steinheim (DE)

(21) Appl. No.: 18/021,822

(22) PCT Filed: Jul. 26, 2021
(86) PCT No.: PCT/EP2021/070832

§ 371 Date: Feb. 17, 2023

(30) Foreign Application Priority Data
Aug. 20, 2020 (BE) BE2020/5577

(51) Int. Cl. H01R 9/24; B29C 65/16

(52) U.S. Cl. CPC H01R 9/2475; H01R 9/2416; B29C 65/1635; B29L 2031/36

(57) ABSTRACT

The invention relates to a method for producing an electrical connection arrangement (100), comprising the following method steps: providing at least one connection device (110), the connection device (110) comprising an insulating material housing (112) which has a receiving area (115) for accommodating a marking label (111); providing at least one marking label (111); inserting the at least one marking label (111) into the receiving area (115) of the insulating material housing (112) of the at least one connection device (110); and establishing at least one integrally bonded connection (119) between the at least one marking label (111) and the insulating material housing (112) of the at least one connection device (110) by laser beam welding.

### CROSS-REFERENCE TO PRIOR APPLICATIONS

This application is a U.S. National Phase application under 35 U.S.C. § 371 of International Application No. PCT/EP2021/070832, filed on Jul. 26, 2021, and claims benefit to Belgian Patent Application No. BE 2020/5577, filed on Aug. 20, 2020. The International Application was published in German on Feb. 24, 2022 as WO/2022/037904 under PCT Article 21(2).

### FIELD

The present invention relates to a method for producing an electrical connection arrangement. The invention further relates to such an electrical connection arrangement.

### BACKGROUND

In control cabinets, marking plates are used to indicate, for example, the connections of connection terminals, terminal blocks, plug connectors and the like, hereinafter generally referred to as connection devices. The marking plates are themselves, for example, directly attached to the connection devices, in particular to the insulating-material housings of the connection devices. For this purpose, the marking plates usually have a clamping geometry in the region of their foot portion in order to be accommodated in a form-fitting and/or force-fitting manner in a recess of the insulating-material housing of a connection device.

It has been shown that simply jamming the marking plates into a recess of an insulating-material housing is suitable only to a limited extent for automated production. It is thus possible for the marking plates to come loose or slip out of the desired position due to vibrations, shocks or other dynamic influences during the automated handling of the connection devices, so that a subsequent automated labeling of the marking plates is not possible. Up to now, therefore, it has not been possible to use such clampable marking plates in automated production of the connection devices.

### SUMMARY

In an embodiment, the present invention provides a method for producing an electrical connection arrangement, comprising: providing at least one connection device having an insulating-material housing that has a receiving area configured to receive a marking plate; providing at least one marking plate; inserting the at least one marking plate into the receiving area of the insulating-material housing of the at least one connection device; and forming at least one integrally bonded connection between the at least marking plate and the insulating-material housing of the at least one connection device by laser-beam welding.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a schematic representation of an electrical connection arrangement with a connection device and a marking plate inserted into a recess of the insulating-material housing of the connection device, wherein an integrally bonded connection with the insulating-material housing is formed in the region of the labeling portion of the marking plate,

FIG. 2 shows a schematic representation of a connection arrangement of multiple connection devices as shown in FIG. 1, which are arranged in a row,

FIG. 3 shows a schematic representation of an electrical connection arrangement with a connection device and a marking plate inserted into a recess of the insulating-material housing of the connection device, wherein an integrally bonded connection with the insulating-material housing is formed in the region of the foot portion of the marking plate, and

FIG. 4 shows a schematic representation of the connection arrangement shown in FIG. 3 during laser-beam welding.

### DETAILED DESCRIPTION

In an embodiment, the present invention provides a method for producing an electrical connection arrangement as well as an electrical connection arrangement which enable reliable automated production.

The method for producing an electrical connection arrangement according to the invention is characterized by the following method steps: Providing at least one connection device, wherein the at least one connection device has an insulating-material housing which has a receiving area for receiving a marking plate; providing at least one marking plate; inserting the at least one marking plate into the receiving area of the insulating-material housing of the at least one connection device; and forming at least one integrally bonded connection between the at least one marking plate and the insulating-material housing by laser-beam welding.

By forming an integrally bonded connection by means of laser-beam welding between the marking plate inserted into the receiving area and the insulating-material housing, a reliable fastening of the marking plate on the insulating-material housing can be achieved, which does not even come loose due to transport-related vibrations or shocks during automated production. For example, a connection device, such as a terminal block can thus be provided with one or more marking plates which, in the context of automated control cabinet production, are first mounted on a support rail, after which the one or more marking plates accommodated in the insulating-material housing of the connection device are labeled without the risk of a marking plate or multiple marking plates being lost during the entire process. By means of the integrally bonded connection between the marking plate and the insulating-material housing, a positionally correct or positionally secure arrangement of the marking plate on the insulating-material housing can be ensured so that errors during any subsequent labeling of the marking plate, in particular in the case of automated labeling of the marking plate, can be prevented. The integrally bonded connection can be formed by a punctiform or a linear weld seam between the marking plate and the insulating-material housing. The receiving area is preferably formed on an outer surface of the insulating-material housing. The receiving area can, for example, take the form of a recess, notch, opening, groove, etc. in the insulating-material housing. The receiving area enables a defined positioning of the marking plate on the insulating-material housing of the connection device.

The connection device can be a connection terminal, a terminal block, a plug connector or the like. The connection device preferably has at least one connection element inside the insulating-material housing, via which, for example, a cable or a conductor or a mating plug connector can be contacted. The connection element can take the form of a spring-force terminal connection, a screw connection, an insulation-piercing connection or the like.

Laser-beam welding takes place in particular in such a way that, starting from a laser beam source, a laser beam is directed onto a region of the insulating-material housing and onto a region of the marking plate. Both the region of the insulating-material housing and the region of the marking plate can be melted by means of the laser beam so that a melt is produced in this melted region of the insulating-material housing and in this melted region of the marking plate, whereby the melts can at least partially mix in order to form the integrally bonded connection. The region of the insulating-material housing and the region of the marking plate, which are melted by means of the energy of the laser beam, are preferably arranged directly adjacent to or contiguous with one another when the marking plate has been inserted in the receiving area. The region of the insulating-material housing, which is melted by means of the laser beam, can be, for example, a wall of the insulating-material housing that delimits the receiving area. Furthermore, this region can also be formed in the region of the outer surface of the insulating-material housing.

It can be provided that the insulating-material housing comprises one of the following plastics at least in the region of the integrally bonded connection that is to be formed: acrylonitrile-butadiene-styrene copolymer (ABS), polystyrene (PS), polycarbonate (PC), styrene-acrylonitrile copolymers (SAN) or polymethyl methacrylate (PMMA), such as polypropylene (PP), polyamide (PA), polyimide (PI) polyoxymethylene (POM) or polyethylene (PE), polyarylsulfones (PSU, PPSU), polyether ether ketone (PEEK), polyester (PES), polyethylene terephthalate (PET), silicone. One region of the receiving area is preferably the region where the insulating-material housing is melted by means of the energy of the laser beam in order to form the integrally bonded connection. It has been found particularly advantageous if the insulating-material housing has a polyamide, in particular a polyamide 6.6, or consists of a polyamide, in particular a polyamide 6.6, at least in the region of the integrally bonded connection that is to be formed.

It can be provided that the marking plate comprises one of the following plastics or consists of one of the following plastics: acrylonitrile-butadiene-styrene copolymer (ABS), polystyrene (PS), polycarbonate (PC), styrene-acrylonitrile copolymers (SAN) or polymethyl methacrylate (PMMA), such as polypropylene (PP), polyamide (PA), polyimide (PI) polyoxymethylene (POM) or polyethylene (PE), polyarylsulfones (PSU, PPSU), polyether ether ketone (PEEK), polyester (PES), polyethylene terephthalate (PET), silicone. It has been found that it is particularly advantageous if the marking plate comprises a polyamide, in particular a polyamide 6.6, or consists of a polyamide, in particular of a polyamide 6.6.

The plastic material of the marking plate and the plastic material of the insulating-material housing are selected in such a way that they can be welded together by laser-beam welding or can be melted or melted on at least in subregions. In order to be able to achieve good weldability and/or meltability, the plastic material of the marking plate and the plastic material of the insulating-material housing are preferably selected such that they have a similar, in particular the same, melting point. For the marking plate and the insulating-material housing, plastic materials are preferably selected which are of similar types so that they have at least very similar properties, in particular a very similar melting behavior.

After laser-beam welding and thus after the formation of the integrally bonded connection between the insulating-material housing and the marking plate, a labeling and/or marking of the marking plate can take place. Labeling and/or marking can take place, for example, by laser labeling using a UV laser or CO2 laser. The labeling and/or marking of the marking plate can be carried out automatically so that both the fastening of the marking plate to the insulating-material housing and the labeling and/or marking of the fastened marking plate can be carried out automatically.

Alternatively, however, it is also possible for the marking plate to be labeled prior to laser-beam welding and thus before the integrally bonded connection with the insulating-material housing is formed. An already labeled marking plate can thus be connected to the insulating-material housing.

Instead of laser marking, alternative labeling or marking methods for labeling and/or marking the marking plate can also be used, such as inkjet printing, pad printing or the like.

The marking plate preferably has a labeling portion and a foot portion, wherein the marking plate in the region of its labeling portion can be integrally bonded to the insulating-material housing by means of laser-beam welding and/or wherein the marking plate in the region of its foot portion can be connected in a integrally bonded manner to the insulating-material housing by means of laser-beam welding. The foot portion is the portion with which the marking plate is inserted into the receiving area. In the inserted state of the marking plate in the receiving area, the labeling portion of the marking plate can project at least in regions from the receiving area, in particular when the receiving area takes the form of a recess. The foot portion can have two tabs, in particular two projecting tabs, whereby in the region of these tabs the integrally bonded connection with the insulating-material housing and thus the welding can be formed.

For pre-fastening the marking plate on the insulating-material housing, it can be provided that, before laser-beam welding, the marking plate is fastened in a form-fitting and/or force-fitting manner in the receiving area of the insulating-material housing. In particular, it can be provided that the foot portion of the marking plate, for example the tabs of the foot portion of the marking plate, can engage in undercuts or latching grooves of the receiving area of the insulating-material housing and/or can be clamped in the receiving area of the insulating-material housing in order to connect the marking plate to the insulating-material housing in a form-fitting and/or force-fitting manner. In addition to the integrally bonded connection by means of laser-beam welding, the marking plate can thus be connected in a form-fitting and/or force-fitting manner to the insulating-material housing of the connection device. Instead of tabs, the foot portion can also have, for example, one or more latching lugs or latching hooks for forming a form-fitting and/or force-fitting pre-fastening on the insulating-material housing.

According to an alternative embodiment, it can be provided that the foot portion of the marking plate takes the form of a planar surface. The foot portion of the marking plate in that case will have no tabs or the like, so that no form-fitting or force-fitting connection of the marking plate to the insulating-material housing can be formed in the region of the receiving area. The marking plate can then be connected to the insulating-material housing exclusively by integral bonding by laser-beam welding.

In particular, it is provided that no bonding of the marking plate to the insulating-material housing is effected by means of an adhesive. Accordingly, an additional adhesive is preferably dispensed with entirely.

In particular, during laser-beam welding, a homogeneous melting together of contiguous plastic materials of the marking plate and of the insulating-material housing takes place.

The strength of an integrally bonded connection formed between the marking plate and the insulating-material housing can be set via the welding parameters of the laser-beam welding.

For example, the strength of the welded connection can be set in such a way that a mechanical breaking of the integrally bonded connection between the marking plate and the insulating-material housing can be effected without tools in order to enable an exchange of a marking plate in a quick and simple manner. Alternatively, the strength of a welded connection can be set in such a way that a mechanical breaking of the integrally bonded connection between the marking plate and the insulating-material housing can be effected with the aid of a tool, such as, for example, a screwdriver or the like, in order to enable an exchange of a marking plate.

Furthermore, it can be provided that at least two connection devices are provided which are arranged in a row, wherein in each case a marking plate can be inserted into the receiving area of the respective insulating-material housing of the at least two connection devices, wherein a laser beam can be moved along the at least two connection devices in order to form the laser-beam welding in order to connect the marking plates to the respective insulating-material housing by integral bonding. The welding of the marking plates to the respective insulating-material housings of two or more connection devices can thus take place directly one after the other and thus take place almost simultaneously. Either the laser beam can be moved along the connection devices arranged in a row or the connection devices arranged in a row can be arranged on a carrier which can be moved past a stationary laser beam.

In an embodiment, the invention provides an electrical connection arrangement, with at least one connection device, wherein the at least one connection device has an insulating-material housing which has a receiving area for receiving a marking plate, and with at least one marking plate, wherein the marking plate is inserted into the receiving area of the insulating-material housing of the at least one connection device, and wherein the at least one marking plate inserted into the receiving area and the insulating-material housing are integrally connected to one another by laser-beam welding.

As a result, a cost-effective electrical connection arrangement optimized for automated assembly methods can be specified, wherein a loss of the marking plate due to transport-related shocks or vibrations can be reliably avoided by means of the integrally bonded connection between the marking plate and the insulating-material housing.

The marking plate can have a labeling portion and a foot portion, wherein the marking plate in the region of its labeling portion can be bonded to the insulating-material housing by means of laser-beam welding and/or the marking plate in the region of its foot portion can be connected in an integrally bonded manner to the insulating-material housing by means of laser-beam welding. The labeling portion preferably takes the form of a flat or planar surface. An inscription of the marking plate can be applied or applied on the labeling portion. The foot portion preferably directly adjoins the labeling portion. Preferably, the foot portion and the labeling portion are formed integrally with one another. The arrangement of the marking plate in the receiving area of the insulating-material housing preferably takes place via the foot portion. The foot portion can have, for example, two tabs, in particular two projecting tabs. In the region of these tabs, in particular at a free end of the tabs, the integrally bonded connection of the marking plate to the insulating-material housing can be formed.

In order to be able to form a particularly secure connection between the marking plate and the insulating-material housing, it can be provided that the marking plate is connected to the insulating-material housing in a form-fitting and/or force-fitting manner in addition to the integrally bonded connection. This can be formed, for example, by the foot portion of the marking plate, for example the tabs of the foot portion, engaging in provided undercuts or grooves of the receiving area and/or being clamped in the receiving area itself, in particular clamped resiliently elastically.

Furthermore, it can be provided that at least two connection devices are provided which are arranged in a row, wherein in each case one marking plate can be inserted into the receiving area of the respective insulating-material housing of the at least two connection devices, wherein each of the marking plates can be connected in each case to the respective insulating-material housing by means of laser-beam welding.

For example, it can be provided that the two or more connection devices are provided in the form of terminal blocks, so that the electrical connection arrangement has a plurality of terminal blocks arranged in a row, each of which is fitted with associated marking plates, which can be automatically labeled after the integrally bonded connection to the insulating-material housing of the respective connection device.

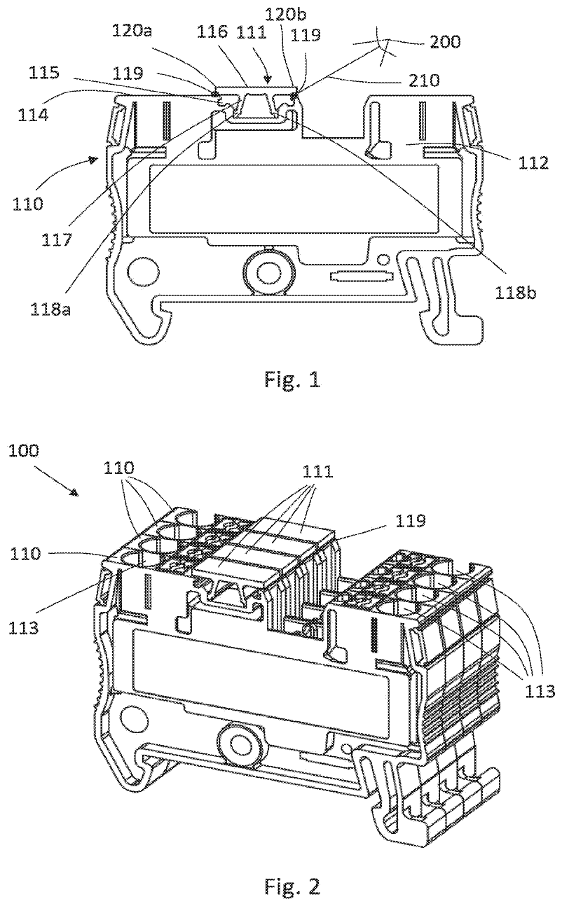

FIG. 1 shows a connection arrangement 100 with a connection device 110 and a marking plate 111 arranged on the connection device 110 for labeling or marking the connection device 110.

The connection device 110 here takes the form of a terminal block. The connection arrangement 110 also comprises an insulating-material housing 112. The insulating-material housing 112 here has two openings 113, through which an electrical conductor can be inserted into the insulating-material housing 112 in order to connect it. Connecting elements, such as spring-force terminal connections, are arranged within the insulating-material housing 112 in order to electrically contact the conductors inserted via the openings 113.

In order to fasten the marking plate 111 to the insulating-material housing 112, a receiving area 115 is formed on an outer surface 114 of the insulating-material housing 112, in or on which the marking plate 111 is received. The receiving area 115 here takes the form of a recess in the insulating-material housing 112. The marking plate 111 is inserted into this recess in such a way that the marking plate 111 at least partially enters the recess and thus the receiving area 115.

The marking plate 111 has a labeling portion 116 and a foot portion 117.

A labeling or marking can be applied or applied to the labeling portion 116 on the marking plate 111. The labeling portion 116 takes the form of a flat or planar surface.

The foot portion 117 is directly connected to the labeling portion 116. The foot portion 117 is integrally formed with the labeling portion 116 so that the entire marking plate 111 is formed in one piece. With the foot portion 117, the marking plate 111 enters the recess and thus the receiving area 115. In the embodiment shown here, the foot portion 117 has two tabs 118a, 118b which extend away from the labeling portion 116. The tabs 118a, 118b are arranged at an angle to one another so that the two tabs 118a, 118b form a V-shape. By means of the tabs 118a, 118b, the marking plate 111 can be clamped or braced in the receiving area 115 via its foot portion 117, as a result of which a type of pre-assembly of the marking plate 111 on the insulating-material housing 112 can take place.

If the marking plate 111 has been inserted into the receiving area 115, laser-beam welding is carried out to fasten the marking plate 111 to the insulating-material housing 112, as a result of which an integrally bonded connection 119 is formed between the marking plate 111 and the insulating-material housing 112. Laser-beam welding is performed by a laser beam 210 emitted by a laser source 200. The laser beam 210 impinges directly on the region of the marking plate 111 and on the region of the insulating-material housing 112 where the integrally bonded connection 119 is to be formed. By means of the laser beam 210, a region of the marking plate 111 and a region of the insulating-material housing 112 are in each case melted to form the integrally bonded connection 119 in these regions. In a cooled state the integrally bonded connection 119 takes the form of a weld seam. This weld seam can be of punctiform or linear design.

In the embodiment shown in FIG. 1, the integrally bonded connection 119 with the insulating-material housing 112 is made in the region of the labeling portion 116 of the marking plate 111. The integrally bonded connection 119 is formed on two opposite edge faces 120a, 120b of the labeling portion 116 of the marking plate 111. The region of the insulating-material housing 112 in which the integrally bonded connection 119 is formed lies within the region of the outer surface 114 of the insulating-material housing 112.

FIG. 2 shows a connection arrangement 100 with multiple connection devices 110 arranged in a row, as shown in FIG. 1, to each of which a marking plate 111 is integrally bonded. The integrally bonded connection 119 extends in a line along the connection devices 110 in the region of the labeling portion 116 of the marking plates 111. Here, when the connection devices 110 are already arranged in a row, the laser beam 210 can be moved along the connection devices 110 so that simultaneous welding of the individual marking plates 111 to the respective insulating-material housings 112 of the individual connection devices 110 can take place. This enables a particularly rapid and secure fastening of the marking plates 111 to a plurality of connection devices 110.

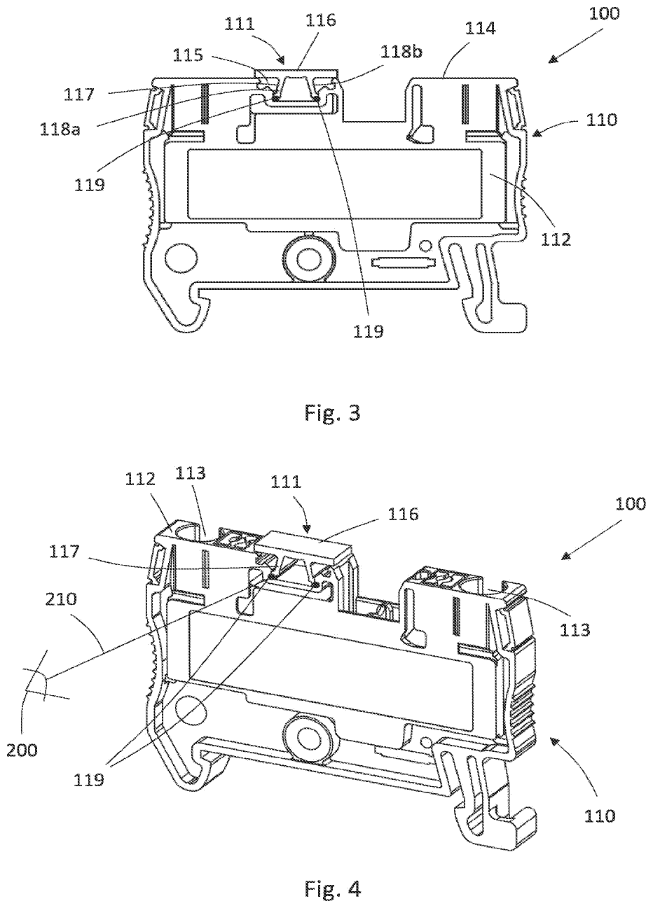

FIGS. 3 and 4 each show a connection arrangement 110 in which the connection device 110 and the marking plate 111 are of identical design to the representation shown in FIG. 1.

In the embodiment shown in FIGS. 3 and 4 the integrally bonded connection 119 between the marking plate 111 and the insulating-material housing 112 is formed between the foot portion 117 of the marking plate 111 and the insulating-material housing 112. The region of the marking plate 111, which is melted by the laser beam 210, is in each case a free end of the two tabs 118a, 118b of the foot portion 117 of the marking plate 111. The region of the insulating-material housing 112 which is melted by means of the laser beam 210 lies in the receiving area 115 of the insulating-material housing 112. In this embodiment, the integrally bonded connection 119 is formed on each connection device 110 individually.

In the embodiments shown in FIGS. 1 to 4, the insulating-material housing 112 and the marking plate 111 are made of a material of the same type, at least in the region of the formation of the integrally bonded connection 119. For example, both the insulating-material housing 112 and the marking plate 111 can be made of a polyamide, in particular a polyamide 6.6.

In order to produce the electrical connection arrangement 100, in the embodiments shown in FIGS. 1 to 4, the connection device 110 is initially provided in one method step. The marking plate 111 is inserted into the receiving area 115 of the insulating-material housing 112 of the connection device 110. In this state, the marking plate 111 is pre-fastened in the receiving area 115, since the marking plate 111 is held within the receiving area 115 in a form-fitting and force-fitting manner by the tabs 118a, 118b of the foot portion 117.

To weld the marking plate 111 to the insulating-material housing 112, starting from a laser source 200, a laser beam 210 is directed onto the marking plate 111 and the insulating-material housing 112. In the embodiment shown in FIGS. 1 and 2, the laser beam 210 is directed onto a region of the fastening portion 116 of the marking plate 111. In the embodiment shown in FIGS. 3 and 4, the laser beam 210 is directed onto a region of the foot portion 117 of the marking plate 111. The laser beam 210 causes local melting and thus fusing of the plastic material of the marking plate 111 with the plastic material of the insulating-material housing 112 so that an integrally bonded connection 119 is formed between the insulating-material housing 112 and the marking plate 111.

Before or after the integrally bonded connection of the marking plate 111 to the insulating-material housing 112, the labeling portion 116 of the marking plate 111 can be inscribed or marked.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 Connection arrangement
110 Connection device
111 Marking plate
112 Insulating-material housing
113 Opening
114 Outer surface
115 Receiving area
116 Fastening portion
117 Foot portion
118a, 118b Tab
119 Integrally bonded connection
120a, 120b Edge face
200 Laser source
210 Laser beam

1. A method for producing an electrical connection arrangement, comprising:
providing at least one connection device having an insulating-material housing that has a receiving area configured to receive a marking plate;
providing at least one marking plate;
inserting the at least one marking plate into the receiving area of the insulating-material housing of the at least one connection device; and
forming at least one integrally bonded connection between the at least marking plate and the insulating-material housing of the at least one connection device by laser-beam welding.

2. The method according of claim 1, wherein when the laser-beam welding is carried out, a laser beam is directed onto a region of the at least one marking plate and onto a region of the insulating-material housing on which the integrally bonded connection is formed.

3. The method according of claim 1, wherein the insulating-material housing has comprises a polyamide, or comprises a polyamide at least in a region of the integrally bonded connection that is to be formed.

4. The method of claim 1, wherein the at least one marking plate comprises a polyamide.

5. The method of claim 1, wherein a labeling and/or marking of the at least one marking plate inserted into the receiving area takes place after laser-beam welding.

6. The method of claim 1, wherein the at least one marking plate comprises a labeling portion and a foot portion,
wherein the at least one marking plate is integrally bonded to the insulating-material housing in a region of the labeling portion by laser-beam welding, and/or
wherein the at least one marking plate is integrally bonded to the insulating-material housing in a region of the foot portion by laser-beam welding.

7. The method of claim 1, wherein, before the laser-beam welding, the at least one marking plate is fastened in the receiving area in a form-fitting and/or force-fitting manner.

8. The method of claim 1, wherein at least two connection devices are provided, which are arranged in a row,
wherein the at least one marking plate is inserted into the receiving area of the respective insulating-material housing of the at least two connection devices, a laser beam being moved along the at least two connection devices to effect the laser-beam welding, to connect the at least one marking plate to the respective insulating-material housing by integral bonding.

9. An electrical connection arrangement, comprising:
at least one connection device having an insulating-material housing that has a receiving area configured to receive a marking plate; and
at least one marking plate,
wherein the at least one marking plate is inserted into the receiving area of the insulating-material housing of the at least one connection device, and
wherein the at least one marking plate inserted into the receiving area and the insulating-material housing are integrally connected to one another by laser-beam welding.

10. The electrical connection arrangement of claim 9, wherein the at least one marking plate has a labeling portion and a foot portion,
wherein the at least one marking plate is integrally bonded to the insulating-material housing in a region of the labeling portion by laser-beam welding, and/or
wherein the at least one marking plate is integrally bonded to the insulating-material housing in the region of the foot portion by laser-beam welding.

11. The electrical connection arrangement of claim 9, wherein at least two connection devices are provided, which are arranged in a row, and
wherein the at least one marking plate is inserted into the receiving area of the respective insulating-material housing of the at least two connection devices, each marking plate of the at least one marking plate being connected to the respective insulating-material housing by laser-beam welding.
